(19) United States
(12) Patent Application Publication
(10) Pub. No.: US 2015/0218973 A1
(43) Pub. Date: Aug. 6, 2015

(54) Two cycle internal combustion engine

(71) Applicant: William Delaplaine Green, JR., Alexandria, VA (US)

(72) Inventor: William Delaplaine Green, JR., Alexandria, VA (US)

(21) Appl. No.: 14/544,641

(22) Filed: Jan. 27, 2015

Related U.S. Application Data
(60) Provisional application No. 61/965,576, filed on Feb. 3, 2014.

(51) Int. Cl. F01K 23/10; F22B 1/18; F01N 5/02; F02G 5/02; F02B 37/22; F02B 75/02

(52) U.S. Cl. CPC F01K 23/10; F02B 37/22; F02B 75/02; F01N 5/02; F02G 5/02; F22B 1/1807; F02B 2075/025

(57) ABSTRACT

The invention is a Two Cycle Internal Combustion Engine that is supercharged in the opposed twin design where the second engine housing functions as a supercharged steam engine to improve engine output and efficiency by using engine exhaust gas heat to make heat water into steam and to also drive a turbocharger that functions in unison with a positive displacement gear type compressor to make a compound supercharger to increase engine output.

This is a US Provisional Patent Application for a Two Cycle Internal Combustion Engine based on U.S. Provisional Patent Applications Appl. No. 61/965,576, filed Feb. 3, 2014; Appl. No. 61/965,497 filed Jan. 31, 2014; and Appl. No. 61/965,422 filed Jan. 31, 2014.

### INTRODUCTION

This inventor received a US Patent in 2003, U.S. Pat. No. 6,546,901 on a new type of two cycle internal combustion engine. Since then I have filed many US Patent Applications on various embodiments of that invention. Recently, during the past years I have filed versions of the invention that showed how to increase the output and efficiency of the engine by using the exhaust gases of the engine to make steam that is used as a working fluid to make power in addition to using the combustion gases produced by the two cycle engine that force a piston to move between TDC and BDC to drive a crankshaft, piston and rod assembly to produce engine horsepower.

The instant invention focuses on improving the heat transfer between the engine exhaust gas of the two cycle internal combustion engine and the water that the engine exhaust gases heats into steam by forcing the exhaust gases through a heat exchanger of a unique design.

### DESCRIPTION OF THE DRAWINGS

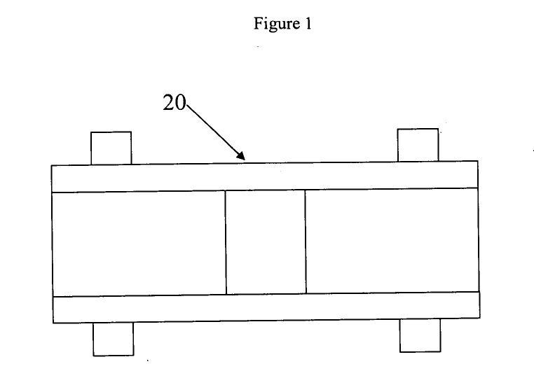

1. The Invention is a Two Cycle Internal Combustion Engine as illustrated in Drawing FIG. 1.

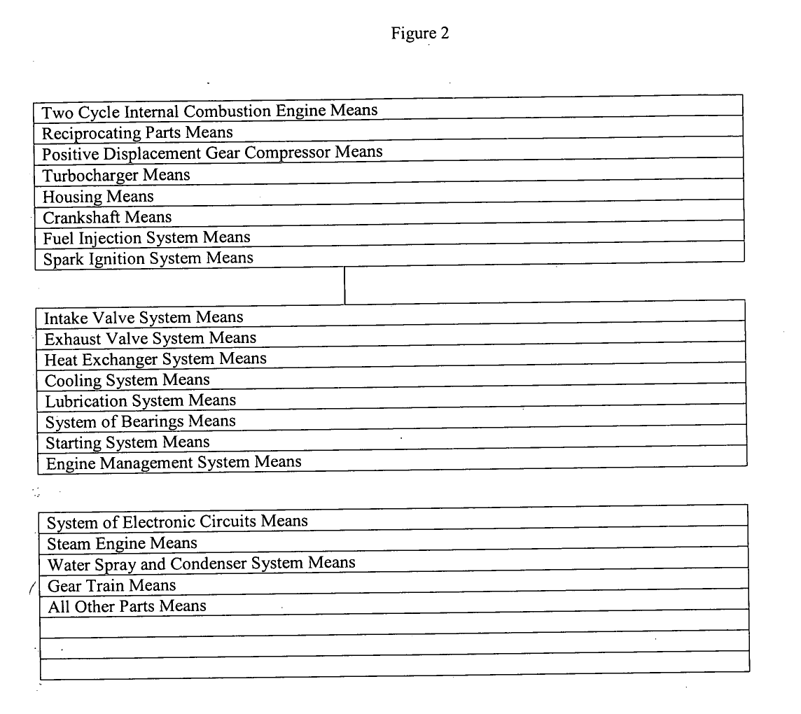

2. Drawing FIG. 2 is a list of Common Means.

### DESCRIPTION OF THE PREFERRED EMBODIMENT

The invention is a Two Cycle Internal Combustion Engine generally referenced by numeral 20. The two cycle internal combustion engine is comprised of an engine housing 22, that is made of two identical housing parts 24 and 26, bolted together by housing bolts 28, threaded into nuts 30. The engine housing contains housing spaces 32, including an air intake port 34, formed in the top surface 36, of the engine housing that encloses a partial cylinder 38, that contains a positive displacement gear compressor gear shaft 40, and a partial cylinder 42, that contains a positive displacement gear shaft 44, that the air intake connects to. The partial cylinders connect to an air outlet port 46 that encloses a fuel injector hole 48 to contain a fuel injector 50 and a spark ignition hole 52 to contain a spark plug 54. The air outlet port connects to a rectangular opening 56, formed in the engine housing that contains a reciprocating part 58. The reciprocating part is rotationally connected to a crankshaft rod bearing 60 formed on a crankshaft 62 that is located inside a crankcase 64 formed inside the engine housing that encloses a crankshaft output shaft hole 66, to enclose crankshaft output shaft 68 located in housing part 24 and another crankshaft output shaft hole 70, to enclose crankshaft output shaft 72, located in housing part 26.

A second engine house 74 of identical construction is located in opposed form but does not contain either a spark plug or a fuel injector or the holes used for receiving them as is described for engine housing 22. The second engine housing is used as a steam engine and it's crankshaft output shaft 76 is connected to an output gear 78 that meshes with a idler gear 80 rotationally attached to the engine housing that meshes with a compound drive gear 82 attached to the input shaft 84 of a positive displacement gear shaft 86 of the second engine housing and that first drive gear meshes with a second compound drive gear 88 attached to an output shaft 90 of the positive displacement gear shaft 40 of the first engine housing. The second drive gear is meshed with a second idler gear 92 rotationally attached to the first engine housing and meshes with a second output gear 94 attached to the first crankshaft output shaft 68 for a power transfer between crankshaft output shaft 68 of the first engine housing and the crankshaft output shaft 76 of the second engine housing so that the power generated by the two cycle internal combustion engine is combined with the power output of the two cycle steam engine of the second engine housing.

Rectangular opening 56 encloses an exhaust port 96 in a side wall 98 located near the compressor end of rectangular opening 56. A heat exchanger housing 100 is attached to the side wall of both engine housings sealing around the exhaust port 96 in rectangular opening 56 to connect it to intake port 102 formed in the second rectangular opening 104 formed in a side wall 106 of the second engine housing and located near the compressor end of the second rectangular opening. Heat exchanger housing contains an exhaust passage 108 that connects to the outside surface of engine housing 22 and it is aligned with the exhaust port 96 for a passage of exhaust gases from the exhaust port 96 into the exhaust passage 108. Exhaust passage 108 connects, to the exhaust outlet 110 formed in the opposite end of the heat exchanger for a release of exhaust gases out of the engine. The exhaust passage 108 outer surface 110 is lined with cooling fins inside and outside for a transfer of heat from the engine exhaust gases 112 and the heat exchanger to heat water 114 sprayed by water sprayer 116 onto the exterior heat exchanger fins 118 to make steam 120. The steam inside the heat exchanger is held within the heat exchanger by exhaust valve 122 covering exhaust port 96 and intake valve 124 covering intake port 102 to prevent steam from escaping from the heat exchanger.

Cam lobe 126 formed on the positive displacement gear shaft 40 is rotationally connected to pushrod 128 that slidably fits inside of pushrod hole 130 formed on the outside the engine housing 22 and is slidably connected to the lever 132 formed on the outside of the exhaust valve to push the exhaust valve inward to open the exhaust port when the reciprocating means inside the engine housing 22 reaches bottom dead center. Cam lobe 134 formed on the positive displacement gear shaft 86 is rotationally connected to pushrod 136 that slidably fits inside of pushrod hole 138 formed on the outside the engine housing 74 and is slidably connected to the lever 140 formed on the outside of the steam exit valve to push the steam exit valve outward to open the steam exit port when the reciprocating means inside the engine housing 74 reaches bottom dead center so that the steam inside the engine housing is forced into the heat exchanger where it came from during the crankshaft rotation as the reciprocating means moves from BDC to TDC position of crankshaft rotation to begin a new power stroke.

A steam engine intake valve 142 is located by the engine housing steam intake port 144 that is connected to the steam exit passage 146 in the heat exchanger to control the flow of steam into the positive displacement gear compressor to compress the steam into the steam engine housing during the engine power stroke to force the reciprocating part 148 from the TDC position to the BDC position of crankshaft rotation to increase the power and efficiency of the engine.

A turbocharger 150 exhaust inlet port 152 is connected to the exhaust outlet of the heat exchanger. The turbocharger compressor air outlet 154 is connected to the compressor inlet 156 of the engine housing 22 air intake 34 to turbocharger the air flowing into the Two Cycle Internal Combustion Engine positive displacement gear compressor 158 to form a compound supercharger 160 for the Two Cycle Internal Combustion Engine.

A water spray system 162 including a condenser unit 164 and water sprayer 116 connected to the heat exchanger to receive steam extracted from the steam engine housing to condense the steam into water and return the water to the water sprayer system.

A spark ignition system 166, if desired, is attached to the engine to fire the engine spark plug at the desired time. A fuel injection system 168 is also attached to the engine so that the fuel injector will spry fuel into the engine at the desired time. A lubrication system 170 is provided to lubricate the internal moving parts of the engine. A heat exchanger system 172 for converting engine heat into steam pressure. A system of bearings 174 may be used to support rotating engine parts. A starting system 176 is provided to start the Two Cycle internal Combustion Engine. An engine management system 178 may be provided to manage engine operation and provide the engine operator a means to turn the engine on and off and control engine output. A system of electronic circuits 180, wires 182, and mechanical gages 184, sensors 186, regulators 188, transducers 190, integrated circuits 192, CPU's 194, fuses 196, transmitters 198, receivers 200 and all other parts 202 is provided as common means well known in the art so that the engine operation can be monitored and controlled by the engine management system and the engine operator.

This US Provisional Application is intended to explain and illustrate the specifications and drawing of the invention to the reader and when combined with the listed Claims many different and useful embodiments of the invention can be conceived by the reader without departing from the scope of the invention. Any use, manufacture or sales of the invention as illustrated, described and claimed in this US Provisional Patent Application or any embodiments of the invention that are within the scope of the claims is strictly prohibited unless authorized by the Inventor of Record.

### Operation of the Engine

When the engine is started by the engine operator or engine management system the crankshaft of the engine rotates forcing the reciprocating means within the engine and the compressors to compress air into the engine between the reciprocating part and the compressor where the hot air ignites fuel sprayed into the compressed air. The burning fuel mixture forces the reciprocating means to the bottom dead center position at which time the cam lobe on the compressor shaft forces open the engine exhaust valve. During the movement of the reciprocating parts of both engines from BDC to TCD exhaust gases from the two cycle internal combustion engine flow through the exhaust passage into the turbocharger turbine spinning it forcing the turbocharger radial compressor to force more air into the two cycle engine positive displacement gear compressor. As this is occurring the hot exhaust gases flowing through the exhaust passage heat the fins inside and outside on the heat exchanger. The water sprayer sprays water on the heat exchanger fins where steam is created by the evaporation of the water that has contacted the heat exchanger fins. The steam gases fill up the heat exchanger interior and rise the pressure level inside it. The steam engine steam intake passage valve opens at TDC position of steam engine crankshaft rotation and steam enters the steam compressor intake port where it is compressed into the engine housing to force the reciprocating means down from the TDC to the BDC position rotating that crankshaft another 180 degrees to increase engine power and efficiency.

The rotation of the Two Cycle Internal Combustion Engine crankshaft drives the gear train connected to the crankshaft output shaft that drives the idler gear to drive the compressor gear shafts and the second idler gear that drives the steam engine crankshaft of the second engine housing to force the second crankshaft to also move the second reciprocating means from the top dead center position to the bottom dead center position and back up to the top dead center position. When the reciprocating means of the second engine housing is at TDC the cam lobe on the second compressor makes the pushrod to push the intake valve open and let steam from the heat exchanger into the steam engine compressor to force the second reciprocating means from the TDC position to the BDC position. Before the intake valve opens the exhaust valve closes and air inside the Two Cycle Internal Combustion Engine is compressed again between the reciprocation means and the compressor in the engine housing 22. At TDC more fuel is injected into the compressed air and ignition again occurs in the two cycle internal combustion engine forcing the reciprocating part away from TDC position and simultaneously steam pressure enters the steam engine housing and forces the steam engine reciprocating part away from the TDC position to the BDC position to increase engine power and efficiency.

What I claim is:

1. A Two Cycle Internal Combustion Engine comprised of a two cycle internal combustion engine housing for enclosing engine spaces, a reciprocating part for transferring engine power to a crankshaft, a gear drive to transfer crankshaft power to a steam engine crankshaft, a two cycle internal combustion engine positive displacement gear compressor for receiving compressed air from a turbocharger and for compressing air into the two cycle internal combustion engine housing for combustion to force a reciprocating part from the TDC position to the BDC position of crankshaft rotation, a supercharged steam engine positive displacement gear compressor for receiving steam from an intake passage connected to a heat exchanger and for compressing steam received from the intake passage into the steam engine housing to force a reciprocating part from the TDC position to the BDC position of crankshaft rotation simultaneously with the reciprocating parts movement from TDC to the BDC position of crankshaft rotation, a heat exchanger to extract heat from the engine exhaust and turn water into steam pressure, a water spray system including a condenser system to produce water from steam to spray water into the heat exchanger for steam creation inside the heat exchanger, a two cycle internal combustion exhaust passage that passes through the heat exchanger to allow exhaust gas to flow into a turbocharger, a two cycle internal combustion engine exhaust valve assembly to let engine exhaust out of the engine into the exhaust passage, a steam engine intake valve assembly connected to the heat exchanger steam outlet passage to let steam pressure out of the heat exchanger and into the steam engine positive displacement gear compressor steam intake port to compress steam into the steam engine housing to force the steam engine reciprocating part to drive the second crankshaft to increase engine power and efficiency, a fuel injection system to supply fuel to the engine for combustion.

2. The Two Cycle Internal Combustion Engine as described in claim 1 wherein the improvement comprises a turbocharger connected to the exhaust passage outlet to receive exhaust gas from the two cycle internal combustion engine to drive the turbocharger to force compressed air from the turbocharger into the two cycle internal combustion engine positive displacement gear compressor air intake port to increase engine power and efficiency.

3. The Two Cycle Internal Combustion Engine as defined in claim 2 wherein the improvement comprises spark ignition means to ignite fuel and air compressed within the two cycle internal combustion engine housing to cause combustion to occur within the engine housing.

4. The Two Cycle Internal Combustion Engine as defined in claim 3 wherein the improvement comprises the steam engine includes a steam engine housing designed in the opposed twin form including a second crankshaft for converting steam pressure into engine power to increase engine power and efficiency.

5. The Two Cycle Internal Combustion Engine as defined in claim 4 wherein the improvement comprises a gear train to connect the two engine crankshafts output shafts together with the two positive displacement gear compressor shafts.

6. The Two Cycle Internal Combustion Engine as defined in claim 5 wherein the improvement comprises a heat exchanger inlet connected to a steam engine housing steam exit port to receive steam during the BDC to TDC motion of a reciprocating part within the steam engine housing.

7. The Two Cycle Internal Combustion Engine as defined in claim 6 wherein the improvement comprises a steam engine steam exit valve assembly connected to the steam engine housing to open the steam exit port during the BDC to TDC motion of a reciprocating part within the steam engine housing.

8. The Two Cycle Internal Combustion Engine as defined in claim 7 wherein the improvement comprises a heat exchanger outlet connected to a steam engine positive displacement gear compressor steam inlet passage to receive steam during the TDC to BDC motion of a two cycle internal combustion engine reciprocating part within the two cycle internal combustion engine housing.

9. The Two Cycle Internal Combustion Engine as defined in claim 8 wherein the improvement comprises a steam inlet valve assembly connected to the steam engine inlet passage to control the flow of steam from the heat exchanger into the positive displacement gear compressor intake port.

10. The Two Cycle Internal Combustion Engine as defined in claim 9 wherein the improvement comprises A water spray system 162 including a condenser unit 164 and water sprayer 116 connected to the heat exchanger to receive steam extracted from the steam engine housing to condense the steam into water and return the water to the water sprayer system.

11. The Two Cycle Internal Combustion Engine as defined in claim 10 wherein the improvement comprises a spark ignition system 166, if desired, is attached to the engine to fire the engine spark plug at the desired time.

12. The Two Cycle Internal Combustion Engine as defined in claim 11 wherein the improvement comprises a fuel injection system 168 is also attached to the engine so that the fuel injector will spry fuel into the engine at the desired time.

13. The Two Cycle Internal Combustion Engine as defined in claim 12 wherein the improvement comprises a lubrication system 170 is provided to lubricate the internal moving parts of the engine.

14. The Two Cycle Internal Combustion Engine as defined in claim 13 wherein the improvement comprises a heat exchanger system 172 for converting engine heat into steam pressure.

15. The Two Cycle Internal Combustion Engine as defined in claim 14 wherein the improvement comprises a system of bearings 174 may be used to support rotating engine parts.

16. The Two Cycle Internal Combustion Engine as defined in claim 15 wherein the improvement comprises a starting system 176 is provided to start the Two Cycle internal Combustion Engine.

17. The Two Cycle Internal Combustion Engine as defined in claim 16 wherein the improvement comprises an engine management system 178 may be provided to manage engine operation and provide the engine operator a means to turn the engine on and off and control engine output.

18. The Two Cycle Internal Combustion Engine as defined in claim 17 wherein the improvement comprises a system of electronic circuits 180, wires 182, and mechanical gages 184, sensors 186, regulators 188, transducers 190, integrated circuits 192, CPU's 194, fuses 196, transmitters 198, receivers 200.

19. A Two Cycle Internal Combustion Engine comprised of a two cycle internal combustion engine housing for enclosing engine spaces, a reciprocating part for transferring engine power to a crankshaft, a gear drive to transfer crankshaft power to a steam engine crankshaft, a two cycle internal combustion engine positive displacement gear compressor for receiving compressed air from a turbocharger and for compressing air into the two cycle internal combustion engine housing for combustion to force a reciprocating part from the TDC position to the BDC position of crankshaft rotation, a supercharged steam engine positive displacement gear compressor for receiving steam from an intake passage connected to a heat exchanger and for compressing steam received from the intake passage into the steam engine housing to force a reciprocating part from the TDC position to the BDC position of crankshaft rotation simultaneously with the reciprocating parts movement from TDC to the BDC position of crankshaft rotation, a heat exchanger to extract heat from the engine exhaust and turn water into steam pressure, A water system including a condenser unit and water sprayer connected to the heat exchanger to receive steam received from the steam engine housing to condense the steam into water and return the water to the water sprayer system and spray water into the heat exchanger to make steam, a two cycle internal combustion exhaust passage that passes through the heat exchanger to allow exhaust gas to flow into a turbocharger, a two cycle internal combustion engine exhaust valve assembly to let engine exhaust out of the engine into the exhaust passage, a steam engine intake valve assembly connected to the heat exchanger steam outlet passage to let steam pressure out of the heat exchanger and into the steam engine positive displacement gear compressor steam intake port to compress steam into the steam engine housing to force the steam engine reciprocating part to drive the second crankshaft to increase engine power and efficiency, a fuel injection system to supply fuel to the engine for combustion;
A turbocharger connected to the exhaust passage outlet to receive exhaust gas from the two cycle internal combustion engine to drive the turbocharger to force compressed air from the turbocharger into the two cycle internal combustion engine positive displacement gear compressor;
A steam engine housing designed in the opposed twin form including a second crankshaft for converting steam pressure into engine power to increase engine power and efficiency;
A gear train to connect the two engine crankshafts output shafts together with the two positive displacement gear compressor shafts;
A heat exchanger steam inlet passage connected to a steam engine housing steam exit port to receive steam during the BDC to TDC motion of a reciprocating part within the steam engine housing;
A steam engine steam exit valve assembly connected to the steam engine housing to open the steam exit port during the BDC to TDC motion of a reciprocating part within the steam engine housing;
A heat exchanger outlet connected to a steam engine positive displacement gear compressor steam inlet passage to receive steam during the TDC to BDC motion of a two cycle internal combustion engine reciprocating part within the two cycle internal combustion engine housing;
A steam inlet valve system connected to the steam engine inlet passage to control the flow of steam from the heat exchanger into the steam engine positive displacement gear compressor intake port;
A water spray system 162 including a condenser unit 164 and water sprayer 116 connected to the heat exchanger to receive steam extracted from the steam engine housing to condense the steam into water and return the water to the water sprayer system;
A spark ignition system 166, if desired, is attached to the engine to fire the engine spark plug at the desired time;
A lubrication system 170 is provided to lubricate the internal moving parts of the engine;
A heat exchanger system 172 for converting engine heat into steam pressure;
A system of bearings 174 may be used to support rotating engine parts;
A starting system 176 is provided to start the Two Cycle internal Combustion Engine;
An engine management system 178 may be provided to manage engine operation and provide the engine operator a means to turn the engine on and off and control engine output;
A system of electronic circuits 180, wires 182, and mechanical gages 184, sensors 186, regulators 188, transducers 190, integrated circuits 192, CPU's 194, fuses 196, transmitters 198, receivers 200.

20. The Two Cycle Internal Combustion Engine as defined in claim 19 wherein the improvement comprises all other parts 202 is provided as common means well known in the art so that the engine operation can be monitored and controlled by the engine management system and the engine operator.
